(19) United States
(12) Patent Application Publication
(10) Pub. No.: US 2015/0138416 A1
(43) Pub. Date: May 21, 2015

(54) Photo kiosk devices with adjustable housings

(71) Applicants: Yue-Ping Lin, New Taipei (TW); Kun-Hang Jao, Taoyuan (TW); Yao-Ming Liou, Taipei (TW); Hung-Chan Chien, Taipei (TW); Fu-Liang Hsu, Taichung (TW); Chang-Hsien Lee, Taipei (TW); Hui-Ting Yang, Taoyuan (TW)

(72) Inventors: Yue-Ping Lin, New Taipei (TW); Kun-Hang Jao, Taoyuan (TW); Yao-Ming Liou, Taipei (TW); Hung-Chan Chien, Taipei (TW); Fu-Liang Hsu, Taichung (TW); Chang-Hsien Lee, Taipei (TW); Hui-Ting Yang, Taoyuan (TW)

(21) Appl. No.: 13/998,662

(22) Filed: Nov. 21, 2013

(51) Int. Cl. H04N 5/235; H04N 5/232; H04N 5/225

(52) U.S. Cl. CPC H04N 5/2354; H04N 5/2252; H04N 5/2256; H04N 5/23293; H04N 5/23216; H04N 5/23212; H04N 5/23219
USPC 348/333.01

(57) ABSTRACT

The present invention discloses a photo kiosk device. The photo kiosk device may include a housing with an extendable arm to provide a photo taking environment, a digital lens provided at one side of the housing to capture a photo image, a user interface provided at one side of the housing to display the captured photo image; and a photo slot provided at one side of the housing to output a finished photo product of the captured photo image, wherein the extendable arm, when extended, is provided with a back light source at a surface thereof to enhance a brightness of the photo taking environment.

### CROSS-REFERENCE TO RELATED APPLICATIONS

This application is related to and claims priority to U.S. provisional patent application, U.S. Provisional Application No. 61/758,793 filed on Jan. 31, 2013, by the applicants Kun-Huang Jao et al., entitled “The image processing invention of kiosk, human face identify method applied on kiosk, photo taking device, cloud system service on kiosk, peripheral system service applied on kiosk,” and U.S. provisional patent application, U.S. Provisional Application No. 61/786,524 filed on Mar. 15, 2013, by the applicants Yue-Ping Lin et al., entitled “Kiosk device with adjustable housing and applications thereof”.

### FIELD OF THE INVENTION

The present invention relates to photo kiosk devices with adjustable housings; more particularly, the present invention relates to kiosk devices with adjustable housings capable of enhancing a photo taking environment without increasing the size of the devices to provide the best quality photos.

### BACKGROUND OF THE INVENTION

A traditional photo kiosk device with a fixed housing usually occupies a large space in a retail store. This large space is valuable to the retailer, yet the amount of revenues generated by customers paying for the photo developing service provided by the traditional fixed photo kiosk device may not reflect such value.

On the other hand, the traditional photo kiosk device with a non-fixed or adjustable housing may reduce the occupied space, but this kind of kiosks is usually installed with a curtain. If the curtain is installed improperly or the material of the curtain is less than ideal, then the ambient light may affect the quality of the photos taken by the kiosk.

Additionally, the quality of the photos can also be affected if a user stands at a wrong location in relation to the kiosk. In other words, the traditional design of the photo kiosk devices does not take into consideration of the human factors that may prevent the kiosks from producing the best quality photos. For example, improper standing/sitting position of the user may prevent the kiosk from providing the appropriate lighting and/or brightness in the photo-taking environment, thereby outputting photos with less than ideal quality.

Furthermore, the traditional photo kiosk device with the fixed or non-fixed housing must be equipped with a fixed lighting device to provide the appropriate ambient light or a fixed location mark to indicate the proper standing/sitting location so as to optimize the lighting and/or brightness in the photo-taking environment.

To overcome the issues encountered by the traditional photo kiosk device, what is needed is a photo kiosk device that can create an optimal photo taking environment without increasing the size of the device. Additionally, what is needed is a photo kiosk device that can offer easy operating instructions so that users can purchase great quality photos within a short period of time.

### SUMMARY OF THE INVENTION

In light of the drawbacks of the above prior arts, one object of the present invention is to provide a photo kiosk device in such a way that a photo taking environment can be enhanced without increasing the size of the device to provide the best quality photos.

In accordance with one embodiment of the present invention, the photo kiosk device may include a housing with an extendable arm to provide a photo taking environment, a digital lens provided at one side of the housing to capture a photo image, a user interface provided at one side of the housing to display the captured photo image; and a photo slot provided at one side of the housing to output a finished photo product of the captured photo image, wherein the extendable arm, when extended, is provided with a back light source at a surface thereof to enhance a brightness of the photo taking environment.

In accordance with another one embodiment of the present invention, the photo kiosk device may include an adjustable housing. The adjustable housing of the present invention may have two positions, namely the first position and the second position. In the first position, the adjustable housing may have a top protruding from one side of the adjustable housing to provide a photo taking environment, whereas in the second position, the protruding top may be received in the adjustable housing. The photo kiosk device of the present invention may also include a digital lens provided at one side of the adjustable housing to capture a photo image and a user interface also provided at one side of the adjustable housing to display the captured photo image.

Certain embodiments of the invention have other aspects in addition to or in place of those mentioned above. The aspects will become apparent to those skilled in the art from reading of the following detailed description when taken with reference to the accompanying drawings.

### BRIEF DESCRIPTION OF DRAWINGS

FIG. 1a is a schematic side view of a photo kiosk device in accordance with the first embodiment of the present invention;

FIG. 1b is a schematic front view of a photo kiosk device in accordance with the first embodiment of the present invention;

FIG. 2a is a schematic side view of a photo kiosk device in the first position in accordance with the second embodiment of the present invention; and

FIG. 2b is a schematic front view of a photo kiosk device in the second position in accordance with the second embodiment of the present invention.

### DETAILED DESCRIPTION OF THE INVENTION

The following embodiments are described in sufficient detail to enable those skilled in the art to make and use the invention. It is to be understood that other embodiments would be evident based on the present disclosure, and that changes may be made without departing from the scope of the present invention.

The present invention provides a photo kiosk device with an adjustable housing. In particular, the present invention provides a photo kiosk device with an adjustable housing capable of enhancing a photo taking environment without increasing the size of the device to provide the best quality photos. In accordance with the present invention, the photo kiosk device may have a housing with an extendable arm such that, when the extendable arm is extended, a back light source is provided in a photo taking environment created by the extendable arm to enhance the brightness of the photo taking environment. As such, the quality of the photos taken by the photo kiosk device of the present invention is improved.

In one embodiment of the present invention, the photo kiosk device of the present invention may be placed in a retail store, a pharmacy, on the street, or any public or private space. The photo kiosk device of the present invention may develop a photo product of different sizes, such as wallet size, passport picture size, ID picture size, or any customized size, within a short period of time after a photo image is taken. A user may operate the photo kiosk device to select the desired size and number of pictures, take a photo image, adjust the photo image, and make a payment before retrieving a final photo product.

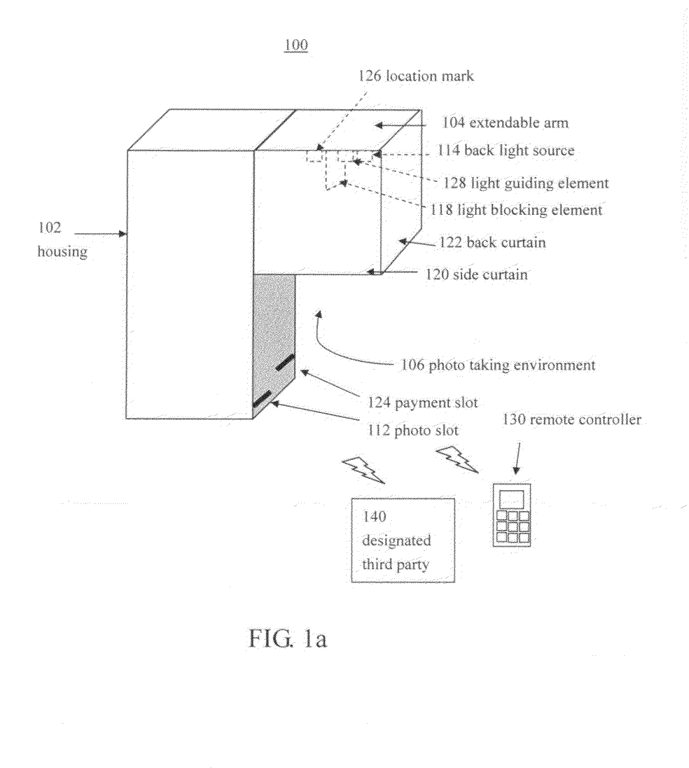

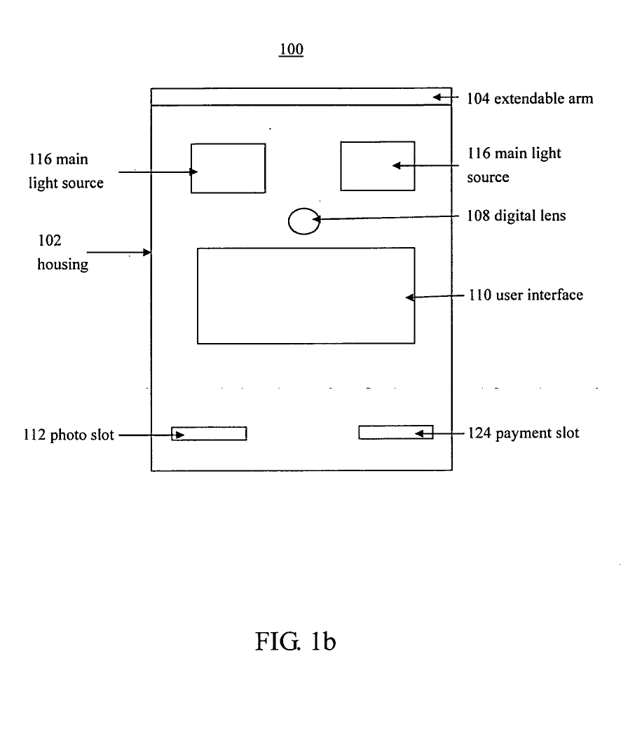

Refer now to FIGS. 1a and 1b, which illustrate a schematic side view and a schematic front view of a photo kiosk device in accordance with one embodiment of the present invention, respectively. As shown in FIGS. 1a and 1b, in one embodiment of the present invention, the photo kiosk device 100 may include a housing 102. In one embodiment of the present invention, the housing 102 may include an extendable arm 104. The extendable arm 104 of the present invention may be extended from one side of the housing 102, such as a top side as shown in FIG. 1a, to create a photo taking environment 106, namely the space below the extendable arm 104. Alternatively, the extendable arm 104 of the present invention may be extended from a left or a right side of the housing 102 to create such photo taking environment 106, namely the space surrounded by the extendable arm 104. Additionally, the extendable arm 104 of the present invention may be received in the housing 102 when it is not extended so as to minimize the space occupied.

As shown in FIG. 1a, in one example, the photo taking environment 106 may be further defined by a side curtain 120 and a back curtain 122 hanging from the extendable arm 104. That is, the photo taking environment 106 may be the space surrounded by the side curtain 120 and the back curtain 122. As such, when the user is to take a photo within the photo taking environment 106, the exterior light may be blocked by the side curtain 120 and the back curtain 122.

In one embodiment of the present invention, a slidable rail (not shown) may be installed on the extendable arm 104 to allow the side curtain 120 and/or the back curtain 122 to slide around the extendable arm 104. In another embodiment of the present invention, a number of hooks may be installed on the extendable arm 104 to affix the side curtain 120 and/or the back curtain 122 to the extendable arm 104. However, those skilled in the art should know that the present invention is not limited to such implementations, any other method allowing the side curtain 120 and/or the back curtain 122 to be placed on the extendable arm 104 temporarily or permanently is within the scope of the present invention.

In one embodiment of the present invention, the side curtain 120 and/or the back curtain 122 may be received within the housing 102 when the extendable arm 104 is not extended. As such, when the extendable arm 104 is extended, the side curtain 120 and/or the back curtain 122 may already be placed around the extendable arm 104. In another embodiment of the present invention, the side curtain 120 and/or the back curtain 122 may be installed manually after the extendable arm 104 is extended.

In one embodiment of the present invention, the side curtain 120 and/or the back curtain 122 may each have two layers. In one example, an interior layer may be made of a material capable of supplementing interior light in the photo taking environment 106, whereas an exterior layer may be made of a material capable of blocking exterior light from coming into the photo taking environment 106. In another embodiment of the present invention, the side curtain 120 and/or the back curtain 122 may each have one layer. In one example, the inner side of the side curtain 120 and/or the back curtain 122 facing the photo taking environment 106 may be made of a material capable of supplementing interior light in the photo taking environment 106, whereas the outer side of the side curtain 120 and/or the back curtain 122 not facing the photo taking environment 106 may be made of a material capable of blocking exterior light from coming into the photo taking environment 106. Preferably, a material made of 10% black color and 90% white color may provide the optimal light supplementing effect. However, any other color ratio may be implemented to provide different imaging effects.

In one embodiment of the present invention, the side curtain 120 and/or the back curtain 122 may be made of a material capable of producing light so as to enhance lighting at an appropriate location in the photo taking environment 106, thereby providing the optimal ambient light in the photo taking environment 106.

In one embodiment of the present invention, as shown in FIG. 1b, a main light source 116 may be provided at one side of the housing 102 to provide sufficient brightness to the photo taking environment 106. A digital lens 108 may be provided on the same side or at a different side of the housing 102 as the main light source 116 so as to capture enough light in the photo taking environment 106. In one embodiment of the present invention, the digital lens 108 may provide auto adjustments based on the brightness in the photo taking environment 106, such as auto white balance, auto exposure, or auto focus, etc., to further improve photo quality.

In one embodiment of the present invention, as shown in FIG. 1a, the extendable arm 104 may be provided with a back light source 114 at a surface thereof so as to further enhance the brightness of the photo taking environment 106. The back light source 114 of the present invention may be implemented in an embedded or exposed manner. As such, the light coming from the back light source 114 may supplement the light provided by the main light source 116 to provide the optimal lighting for the photo taking environment 106 based on the photo requirements selected by the user. In another embodiment of the present invention, the back light source 114 may be installed on the back curtain 122 so as to provide sufficient lighting at different locations within the photo taking environment 106.

In one embodiment of the present invention, the extendable arm 104 may be further provided with a light blocking element 118. The light blocking element 118 of the present invention may be provided between the back light source 114 and the main light source 116 to prevent the digital lens 108 from being over exposed with light. In one embodiment of the present invention, the light blocking element 118 may be provided close to the back light source 114 with a length between 80 mm and 140 mm extending vertically from the extendable arm 104 so as to block a portion of the light coming from the back light source 114.

In one embodiment of the present invention, a location mark 126 may be further provided on the same surface of the extendable arm 104 as the light blocking element 118 to indicate a best standing or sitting location to take a photo image in the photo taking environment 106. Preferably, the location mark 126 is provided between the main light source 116 and the light blocking element 118. As such, the light blocking element 118 may block a portion of the back light going towards the front of the head of the user standing or sitting below the location mark 126, thereby providing the optimal ambient light within the photo taking environment 106.

In another embodiment of the present invention, the extendable arm 104 may be installed with a light guiding element 128 so as to guide additional light to other places within the photo taking environment 106. The light guiding element 128 of the present invention may be installed as an alternative to the light blocking element 118, or the light guiding element 128 may be used together with the light blocking element 118 so as to provide optimal lighting in the photo taking environment 106.

As shown in FIG. 1b, in one embodiment of the present invention, a user interface 110 may be provided at the same side of the housing 102 as the digital lens 108 for the user to operate the device 100. In one example, the user interface 110 of the present invention may be implemented as a touch screen for the user's ease of operation. However, it should be noted that the user interface 110 of the present invention is not limited to such implementation.

The user interface 110 of the present invention may display a photo image captured by the digital lens 108. In one example, the user may operate the photo kiosk device 100 through the user interface 110 to determine whether to purchase the captured image. In another example, the user may select options provided by the user interface 110 to further process the captured image, including but not limited to adding texts or graphic icons onto the captured image, etc. In yet another example, the user interface 110 may display graphic instructions or play audio recordings to guide the user to take the best quality photo.

In yet another example, the user interface 110 may provide a human face detection function to help determine if the captured image satisfies the photo requirements selected by the user. For example, if the user selects to take a passport ID photo, the human face detection function may help determine if the captured image passes the requirements needed for a passport ID photo. In yet another example, the human face detection function provided by the user interface 110 may determine if the distance between where the user is standing and the digital lens 108 is an optimal distance so as to verify if the captured image satisfies the photo requirements selected by the user. In one embodiment of the present invention, the determination of whether the user is standing at the optimal distance may be made by calculating the object distance after the user is focused by the auto focus function of the digital lens 108 with, for example, the following formula:

1/f=1/u+1/v, wherein f is the focal distance, u is the object distance and v is the image distance.

In another embodiment of the present invention, the user interface 110 may determine whether the ambient light within the photo taking environment 106 is optimal based on the user selection. If not, the user interface 110 may direct the user to adjust, for example, the side curtain 120 and/or the back curtain 122, to improve the brightness of the photo taking environment 106.

In one embodiment of the present invention, the photo kiosk device 100 may further include a photo slot 112, as shown in FIGS. 1a and 1b. The photo slot 112 of the present invention may be provided at the same side of the housing 102 as the digital lens 108 and the user interface 110 to output a finished photo product. Alternatively, the photo slot 112 may be provided at a different side of the housing 102 as the digital lens 108 and/or the user interface 110 to output the finished photo product.

In one embodiment of the present invention, the photo kiosk device 100 may further include a payment slot 124, as shown in FIGS. 1a and 1b. The payment slot 124 of the present invention may be used to accept a plurality of payment forms for the finished photo product. In one example, the payment slot 124 may accept cash, credit card, or new field communication (NFC) payment. Take an example of the NFC payment, the user may use a handheld device equipped with the NFC function, such as a cell phone with an NFC-enabled SIM card to perform matching with an NFC sensor (not shown) installed at one side of the photo kiosk device 100. After the matching is done by, for example, Bluetooth or WiFi, the user can then transmit image or data file to the photo kiosk device 100 and make a payment with the NFC-enabled SIM card. In another example, the payment slot 124 may accept other forms of payment known by those ordinarily skilled in the art. The payment slot 124 of the present invention may be provided at the same side of the housing 102 as the digital lens 108 and the user interface 110 to accept the payment. Alternatively, the payment slot 124 may be provided at a different side of the housing 102 from the digital lens 108 and/or the user interface 110 to accept the payment.

In another embodiment of the present invention, the user may also choose to make a payment at a store counter. In such an example, the photo kiosk device 100 of the present invention may include a communication element (not shown) to communicate with the point of sales (POS) system in the store. After the user makes a payment at the counter, the POS system may transmit a message to the communication element or a third party 140 designated by the photo kiosk device 100 to indicate a selected photo product has been paid for so that the user may return to the photo kiosk device 100 to execute the print function and print out the selected photo product. Or, the user may, for example, input a confirmation code or utilize any other confirmation means at the photo kiosk device 100 after the payment is complete so as to print out the finished photo product and/or store the finished photo product in a cloud system. In one example, if the user inputs an incorrect confirmation code or does not pass the confirmation process, the POS system may transmit a message to the communication element within a pre-determined time to cancel the finished photo product temporarily stored in the photo kiosk device 100. Alternatively, the POS system may transmit the message to the communication element to cancel the temporarily stored product at any time.

In another embodiment of the present invention, the photo kiosk device 100 may further include a remote payment mechanism (not shown) to ensure the user has made a payment elsewhere before completing the printing process at the photo kiosk device 100. The remote payment mechanism of the present invention may include a remote controller 130. The remote controller 130 of the present invention may be installed at the store counter or integrated with the POS system in the store. After the user makes a payment at the store counter, the remote controller 130 of the present invention may transmit a message to the photo kiosk device 100 to allow the user to print out the finished photo product. Alternatively, the user may, for example, input a confirmation code or utilize any other confirmation means at the photo kiosk device 100 so as to print out the finished photo product. In one example, if the user inputs an incorrect confirmation code or does not pass the confirmation process, the remote payment mechanism may transmit a message through the remote controller 130 to the photo kiosk device 100 within a pre-determined time to cancel the finished photo product temporarily stored in the photo kiosk device 100. Alternatively, the remote payment mechanism may transmit a message through the remote controller 130 to the photo kiosk device 100 to cancel the temporarily stored product at any time.

In yet another embodiment of the present invention, the photo kiosk device 100 may work with a designated third party 140. As such, after the captured photo image is confirmed to be accurate by the human face detection function of the photo kiosk device 100, the print function may be executed, and the designated third party 140 may receive the finished photo product. For example, the photo kiosk device 100 may provide service to a government institution, such as a licensing office, so as to make an identity document, such as a driver's license, for the government institution. In such an example, after the user confirms the captured photo image is correct or if a biological feature of the user is correctly matched at the photo kiosk device 100, a print button may be pressed so that a staff at the government institution, such as a staff at the licensing office, may receive the finished photo product, which may include but is not limited to a photo, an ID card or any other image output product, etc. In another embodiment of the present invention, the photo kiosk device 100 may be installed in connection with a card printer (not shown). As such, after the user is identified through the biological feature by the human face detection function of the photo kiosk device 100, or after the user enters the correct account and password combination at the photo kiosk device 100, the card printer may write personal information onto a storage element, such as a chip or a magnetic strip, on the card before printing out the identity card so that the user may receive the finished photo product right away.

In yet another embodiment of the present invention, the photo kiosk device 100 may further include an external data access mechanism (not shown) so as to access data stored outside of the photo kiosk device 100. For example, the user may wish to access an image file stored in a tangible device, such as a CF card, SD card, mini SD card, Micro SD card, MS card, XD card, USB, CD or DVD, etc., or an image file stored on the Internet or a cloud system at the photo kiosk device 100.

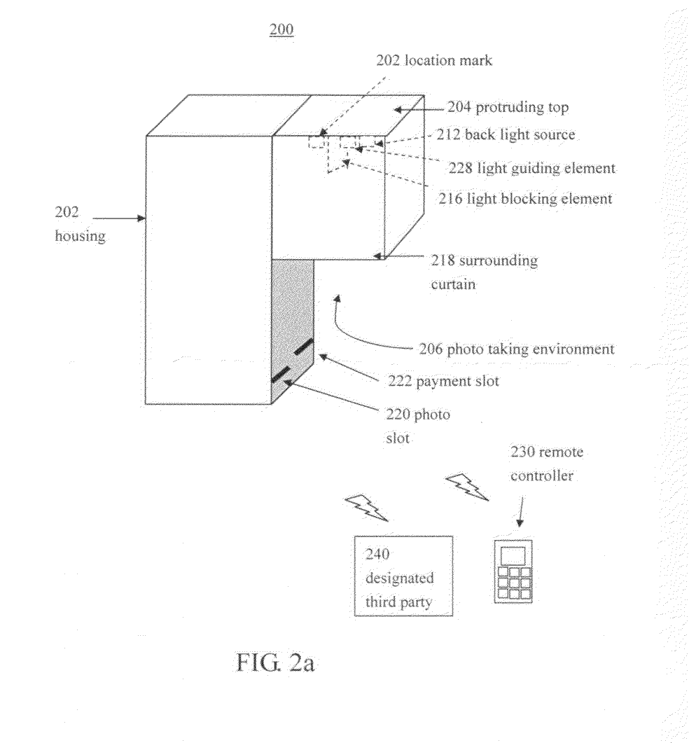

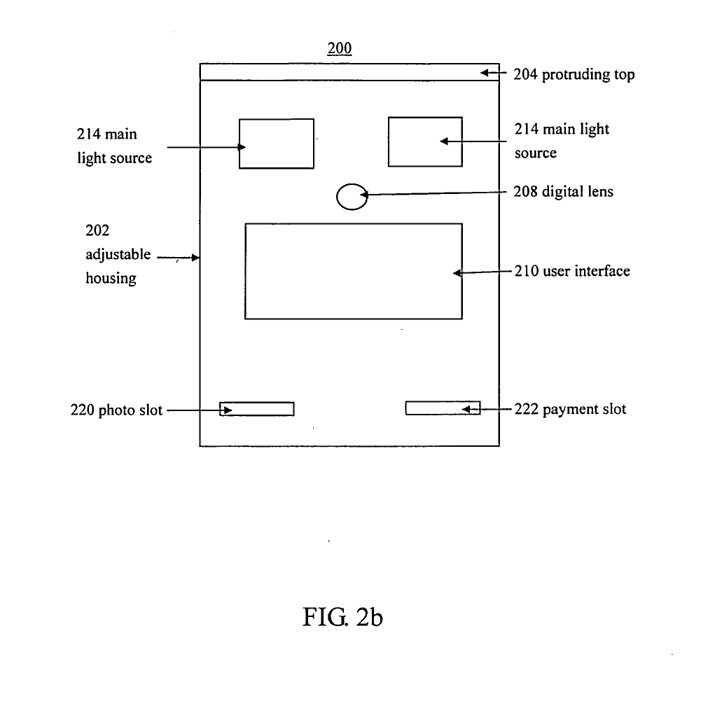

Refer now to FIGS. 2a and 2b, which illustrate a schematic side view of a photo kiosk device in the first position and a schematic front view of a photo kiosk device in the second position in accordance with another embodiment of the present invention, respectively. As shown in FIGS. 2a and 2b, in one embodiment of the present invention, the photo kiosk device 200 may include an adjustable housing 202. In one embodiment of the present invention, the adjustable housing 202 may include a protruding top 204. In the first position of the photo kiosk device 200, the protruding top 204 of the present invention may be protruded from a top side of the adjustable housing 202 to create a photo taking environment 206, namely the space below the protruding top 204, as shown in FIG. 2a. In accordance with the present invention, the photo taking environment 206 created when the photo kiosk device 200 is in the first position may provide the optimal lighting environment to take the best photos. On the other hand, in the second position of the photo kiosk device 200, the protruding top 204 of the present invention may be flexibly accommodated within the adjustable housing 202 to minimize the space occupied. In accordance with the present invention, the user may still operate the photo kiosk device 200 in the second position, such as to further edit a captured photo image.

As shown in FIG. 2a, in one example, the photo taking environment 206 may be further defined by a surrounding curtain 218 provided along the protruding top 204. As such, when the user is to take a photo within the photo taking environment 206, the exterior light may be blocked by the surrounding curtain 218.

In one embodiment of the present invention, a slidable rail (not shown) may be installed along the edges of the protruding top 204 to allow the surrounding curtain 218 to slide around the protruding top 204. In another embodiment of the present invention, a number of hooks may be installed on the protruding top 204 to affix the surrounding curtain 218 to the protruding top 204. However, those skilled in the art should know that the present invention is not limited to such implementations, any other method allowing the surrounding curtain 218 to be placed around the protruding top 204 temporarily or permanently is within the scope of the present invention.

In one embodiment of the present invention, the surrounding curtain 218 may be received within the adjustable housing 202 when the protruding top 204 is accommodated within the adjustable housing 202. As such, when the protruding top 204 is protruded, the surrounding curtain 218 is already placed around the protruding top 204. In another embodiment of the present invention, the surrounding curtain 218 may be installed manually after the protruding top 204 is protruded.

In one embodiment of the present invention, the surrounding curtain 218 may have two layers. In one example, an interior layer may be made of a material capable of supplementing interior light in the photo taking environment 206, whereas an exterior layer may be made of a material capable of blocking exterior light from coming into the photo taking environment 206. In another embodiment of the present invention, the surrounding curtain 218 may have only one layer. In one example, the inner side of the surrounding curtain 218 facing the photo taking environment 206 may be made of a material capable of supplementing interior light in the photo taking environment 206, whereas the outer side of the surrounding curtain 218 not facing the photo taking environment 206 may be made of a material capable of blocking exterior light from coming into the photo taking environment 206. Preferably, a material made of 10% black color and 90% white color may provide the optimal light supplementing effect. However, any other color ratio may be implemented to provide different imaging effects.

As shown in FIG. 2b, in one embodiment of the present invention, a main light source 214 may be provided at one side of the adjustable housing 202 to provide sufficient brightness to the photo taking environment 206. A digital lens 208 may be provided on the same side or at a different side of the adjustable housing 202 as the main light source 214 so as to capture enough light in the photo taking environment 206. In one embodiment of the present invention, the digital lens 208 may provide auto adjustments based on the brightness provided in the photo taking environment 206, such as auto white balance, auto exposure, or auto focus, etc., to further improve photo quality.

In one embodiment of the present invention, as shown in FIG. 2a, the protruding top 204 may be provided with a back light source 212 at a surface thereof so as to further enhance the brightness of the photo taking environment 206. The back light source 212 of the present invention may be implemented in an embedded or exposed manner. As such, the light coming from the back light source 212 may supplement the light provided by the main light source 214 to provide the optimal lighting for the photo taking environment 206 based on the photo requirements selected by the user.

In another embodiment of the present invention, the back light source 212 may be installed on the back curtain 218 so as to provide sufficient lighting at different locations within the photo taking environment 206.

In one embodiment of the present invention, the protruding top 204 may be further provided with a light blocking element 216. The light blocking element 216 of the present invention may be provided between the back light source 212 and the main light source 214 to prevent the digital lens 208 from being over exposed with light. In one embodiment of the present invention, the light blocking element 216 may be provided close to the back light source 212 with a length between 80 mm and 140 mm extending vertically from the protruding top 204 to block a portion of the light coming from the back light source 212.

In one embodiment of the present invention, a location mark 224 may be further provided on the same surface of the protruding top 204 as the light blocking element 216 to indicate a best standing or sitting location to take a photo image in the photo taking environment 206. Preferably, the location mark 224 is provided between the main light source 214 and the light blocking element 216. As such, the light blocking element 216 may block a portion of the back light going towards the front of the head of the user standing or sitting below the location mark 224, thereby providing the optimal ambient light within the photo taking environment 206.

In another embodiment of the present invention, the protruding top 204 may be installed with a light guiding element 228 so as to guide additional light to other places within the photo taking environment 206. The light guiding element 228 of the present invention may be installed as an alternative to the light blocking element 216, or the light guiding element 228 may be used together with the light blocking element 216 so as to provide optimal lighting in the photo taking environment 206.

As shown in FIG. 2b, in one embodiment of the present invention, a user interface 210 may be provided at the same side of the adjustable housing 202 as the digital lens 208 for the user to operate the device 200. In one example, the user interface 210 of the present invention may be implemented as a touch screen for the user's ease of operation. However, it should be noted that the user interface 210 of the present invention is not limited to such implementation.

The user interface 210 of the present invention may display a photo image captured by the digital lens 208. In one example, the user may operate the photo kiosk device 200 through the user interface 210 to determine whether to purchase the captured image. In another example, the user may select options provided by the user interface 210 to further process the captured image, including but not limited to adding texts or graphic icons onto the captured image, etc. In yet another example, the user interface 210 may display graphic instructions or play audio recordings to guide the user to take the best quality photo.

In yet another example, the user interface 210 may provide a human face detection function to help determine if the captured image satisfies the requirements selected by the user. For example, if the user selects to take a passport ID photo, the human face detection function may help determine if the captured image passes the requirements needed for a passport ID photo. In yet another example, the human face detection function provided by the user interface 210 may determine if the distance between where the user is standing and the digital lens 208 is an optimal distance so as to verify if the captured image satisfies the photo requirements selected by the user. In one embodiment of the present invention, the determination of whether the user is standing at the optimal distance may be made by calculating the object distance after the user is focused by the auto focus function of the digital lens 208 with, for example, the following formula:

1/f=1/u+1/v, wherein f is the focal distance, u is the object distance and v is the image distance.

In yet another example, the user interface 210 may determine if the ambient light within the photo taking environment 206 is optimal based on the user selection. If not, the user interface 210 may direct the user to adjust, for example, the surrounding curtain 218 to improve the brightness of the photo taking environment 206.

In one embodiment of the present invention, the photo kiosk device 200 may further include a photo slot 220, as shown in FIGS. 2a and 2b. The photo slot 220 of the present invention may be provided at the same side of the adjustable housing 202 as the digital lens 208 and the user interface 210 to output a finished photo product. Alternatively, the photo slot 220 may be provided at a different side of the adjustable housing 202 as the digital lens 208 and/or the user interface 210 to output the finished photo product.

In one embodiment of the present invention, the photo kiosk device 200 may further include a payment slot 222, as shown in FIGS. 2a and 2b. The payment slot 222 of the present invention may be used to accept a plurality of payment forms for the finished photo product. In one example, the payment slot 222 may accept cash, credit card, or new field communication (NFC) payment. Take an example of the NFC payment, the user may use a handheld device equipped with the NFC function, such as a cell phone with an NFC-enabled SIM card to perform matching with an NFC sensor (not shown) installed at one side of the photo kiosk device 200. After the matching is done by, for example, Bluetooth or WiFi, the user can then transmit image or data file to the photo kiosk device 200 and make a payment with the NFC-enabled SIM card. In another example, the payment slot 222 may accept other forms of payment known by those ordinarily skilled in the art. The payment slot 222 of the present invention may be provided at the same side of the adjustable housing 202 as the digital lens 208 and the user interface 210 to accept the payment. Alternatively, the payment slot 222 may be provided at a different side of the adjustable housing 202 from the digital lens 208 and/or the user interface 210 to accept the payment.

In another embodiment of the present invention, the user may also choose to make a payment at a store counter. In such an example, the photo kiosk device 200 of the present invention may include a communication element (not shown) to communicate with the point of sales (POS) system in the store. After the user makes a payment at the counter, the POS system may transmit a message to the communication element or a third party 240 designated by the photo kiosk device 200 to indicate a selected photo product has been paid for so that the user may return to the photo kiosk device 200 to execute the print function and print out the selected photo product. Or, the user may, for example, input a confirmation code or utilize any other confirmation means at the photo kiosk device 200 after the payment is complete so as to print out the finished photo product and/or store the finished photo product in a cloud system. In one example, if the user inputs an incorrect confirmation code or does not pass the confirmation process, the POS system may transmit a message to the communication element within a pre-determined time to cancel the finished photo product temporarily stored in the photo kiosk device 200. Alternatively, the POS system may transmit the message to the communication element to cancel the temporarily stored product at any time.

In another embodiment of the present invention, the photo kiosk device 200 may further include a remote payment mechanism (not shown) to ensure the user has made a payment elsewhere before completing the printing process at the photo kiosk device 200. The remote payment mechanism of the present invention may include a remote controller 230. The remote controller 230 of the present invention may be installed at the store counter or integrated with the POS system in the store. After the user makes a payment at the counter, the remote controller 230 of the present invention may transmit a message to the photo kiosk device 200 to allow the user to print out the finished photo product. Alternatively, the user may, for example, input a confirmation code or utilize any other confirmation means at the photo kiosk device 200 so as to print out the finished photo product. In one example, if the user inputs an incorrect confirmation code or does not pass the confirmation process, the remote payment mechanism may transmit a message through the remote controller 230 to the photo kiosk device 200 within a pre-determined time to cancel the finished photo product temporarily stored in the photo kiosk device 200. Alternatively, the remote payment mechanism may transmit a message through the remote controller 230 to the photo kiosk device 200 to cancel the temporarily stored product at any time.

In yet another embodiment of the present invention, the photo kiosk device 200 may work with a designated third party 240. As such, after the captured photo image is confirmed to be accurate by the human face detection function of the photo kiosk device 200, the print function may be executed, and the designated third party 240 may receive the finished photo product. For example, the photo kiosk device 200 may provide service to a government institution, such as a licensing office, so as to make an identity document, such as a driver's license, for the government institution. In such an example, after the user confirms the captured photo image is correct or if a biological feature of the user is correctly matched at the photo kiosk device 200, a print button may be pressed so that a staff at the government institution, such as a staff at the licensing office, may receive the finished photo product, which may include but is not limited to a photo, an ID card or any other image output product, etc. In another embodiment of the present invention, the photo kiosk device 200 may be installed in connection with a card printer (not shown). As such, after the user is identified through the biological feature by the human face detection function of the photo kiosk device 200, or after the user enters the correct account and password combination at the photo kiosk device 200, the card printer may write personal information onto a storage element, such as a chip or a magnetic strip, on the card before printing out the identity card so that the user may receive the finished photo product right away.

In yet another embodiment of the present invention, the photo kiosk device 200 may further include an external data access mechanism (not shown) so as to access data stored outside of the photo kiosk device 200. For example, the user may wish to access an image file stored in a tangible device, such as a CF card, SD card, mini SD card, Micro SD card, MS card, XD card, USB, CD or DVD, etc., or an image file stored on the Internet or a cloud system at the photo kiosk device 200.

While the invention has been described in conjunction with exemplary preferred embodiments, it is to be understood that many alternatives, modifications, and variations will be apparent to those skilled in the art in light of the foregoing description. Accordingly, it is intended to embrace all such alternatives, modifications, and variations that fall within the scope of the included claims. The scope of the claims, therefore, should be accorded the broadest interpretation so as to encompass all such modifications and similar arrangements. All matters set forth herein or shown in the accompanying drawings are to be interpreted in an illustrative and non-limiting sense.

What is claimed is:

1. A photo kiosk device, said device comprising:
a housing with an extendable arm to provide a photo taking environment;
a digital lens provided at one side of said housing to capture a photo image;
a user interface provided at one side of said housing to display said captured photo image; and
a photo slot provided at one side of said housing to output a finished photo product of said captured photo image,
wherein said extendable arm, when extended, is provided with a back light source at a surface thereof to enhance a brightness of said photo taking environment.

2. The device of claim 1, further comprising a main light source provided at one side of said housing to provide lighting for said photo taking environment.

3. The device of claim 1, wherein said extendable arm is further provided with a light blocking element between said back light source and said digital lens to provide an optimal photo taking environment.

4. The device of claim 1, wherein said extendable arm is further provided with a side curtain to prevent exterior light from coming into said photo taking environment.

5. The device of claim 1, wherein said extendable arm is further provided with a back curtain to prevent exterior light from coming into said photo taking environment.

6. The device of claim 4, wherein said side curtain has two layers, an interior layer is made of a material capable of supplementing interior light in said photo taking environment, and an exterior layer is made of a material capable of blocking exterior light from coming into said photo taking environment.

7. The device of claim 5, wherein said back curtain has two layers, an interior layer is made of a material capable of supplementing interior light in said photo taking environment, and an exterior layer is made of a material capable of blocking exterior light from coming into said photo taking environment.

8. The device of claim 1, wherein said user interface includes a touch screen for a user to operate said device.

9. The device of claim 1, further comprising a payment slot accepting a plurality of payment forms for said finished photo product.

10. The device of claim 3, wherein said light blocking element has a length between 80 mm and 140 mm extending vertically from said extendable arm to block a portion of light from said back light source.

11. The device of claim 1, wherein said extendable arm is further provided with a location mark at said surface to indicate a best location to take said photo image.

12. A photo kiosk device, said device comprising:
an adjustable housing, said adjustable housing having a first position and a second position, wherein in said first position, said adjustable housing has a top protruding from one side of said adjustable housing to provide a photo taking environment, and wherein in said second position, said protruding top is received in said adjustable housing;
a digital lens provided at one side of said adjustable housing to capture a photo image; and
a user interface provided at one side of said adjustable housing to display said captured photo image.

13. The device of claim 12, wherein said protruding top is further provided with a back light source to enhance a brightness of said photo taking environment.

14. The device of claim 12, further comprising a main light source provided at one side of said adjustable housing to provide lighting for said photo taking environment.

15. The device of claim 13, wherein said protruding top is further provided with a light blocking element between said back light source and said digital lens to provide an optimal photo taking environment.

16. The device of claim 13, wherein said protruding top is further provided with a surrounding curtain to prevent exterior light from coming into said photo taking environment.

17. The device of claim 16, wherein said surrounding curtain has two layers, an interior layer is made of a material capable of supplementing interior light in said photo taking environment, and an exterior layer is made of a material capable of blocking exterior light from coming into said photo taking environment.

18. The device of claim 12, further comprising a photo slot to output a finished photo product of said captured photo image.

19. The device of claim 18, further comprising a payment slot accepting a plurality of payment forms for said finished photo product.

20. The device of claim 12, wherein said protruding top is further provided with a location mark to indicate a best location to take said photo image.

21. The device of claim 1, further comprising a remote controller to transmit a signal remotely so as to control an output of said finished photo product.

22. The device of claim 18, further comprising a remote controller to transmit a signal remotely so as to control an output of said finished photo product.

23. The device of claim 12, wherein said digital lens provides an auto focus function, said auto focus function works in connection with a human face detection function to determine whether a user is at an appropriate location through a formula 1/f=1/u+1/v, wherein f is a focal distance, u is an object distance and v is an image distance.

24. The device of claim 18, further comprising a designated third party to output said finished photo product.

25. The device of claim 1, wherein said digital lens provides an auto focus function, said auto focus function works in connection with a human face detection function to determine whether a user is at an appropriate location through a formula 1/f=1/u+1/v, wherein f is a focal distance, u is an object distance and v is an image distance.

26. The device of claim 1, further comprising a designated third party to output said finished photo product.

27. The device of claim 1, further comprising a light guiding element to guide light to a location within said photo taking environment.

28. The device of claim 12, further comprising a light guiding element to guide light to a location within said photo taking environment.
